(19) United States
(12) Patent Application Publication
(10) Pub. No.: US 2007/0258040 A1
(43) Pub. Date: Nov. 8, 2007

(54) Safety glasses incorporating monitoring systems

(76) Inventor: Benjamin James Randall, Bradbury, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/801,277

(22) Filed: May 8, 2007

Related U.S. Application Data
(60) Provisional application No. 60/798,693, filed on May 8, 2006.

(51) Int. Cl. G02C 1/00

(52) U.S. Cl. 351/158

(57) ABSTRACT

Safety glasses incorporating monitoring systems having at least one battery, a microchip powered by the battery and configured to be responsive to a signal from at least one wireless transmitter to activate the microchip when the safety glasses are in the vicinity of the wireless transmitter unless deactivated by pressure from the bridge of a users nose, the safety glasses having a pair of stems, each having a speaker, a red LED and a vibrator coupled to the microchip and configured to sound an alarm, flash the LEDs and cause a vibration responsive to a signal from a wireless transmitter when the microchip is not deactivated by pressure from the bridge of the users nose.

### CROSS-REFERENCE TO RELATED APPLICATION

This application claims the benefit of U.S. Provisional Patent Application No. 60/798,693 filed May 8, 2006.

### BACKGROUND OF THE INVENTION

1. Field of the Invention

The present invention relates to the field of safety glasses.

2. Prior Art

Safety glasses are commonly required in industrial environments in which eye injury is a possibility. Common safety glasses provide a good degree of protection for the user, if worn. However common safety glasses tend to be cumbersome and not always easy to see through, and the lenses of the safety glasses can get dirty, all of which are characteristics that tend to encourage people to not wear safety glasses even where eye injury is a possibility, resulting in unnecessary accidents and increasing insurance costs.

### BRIEF DESCRIPTION OF THE DRAWINGS

FIG. 1 illustrates an exemplary embodiment of the present invention safety glasses incorporating monitoring systems.

FIG. 2 illustrates the bridge of the safety glasses of the exemplary embodiment of FIG. 1.

### DETAILED DESCRIPTION OF THE PREFERRED EMBODIMENTS

The present invention is to alert surrounding people that someone is not wearing their safety glasses in a designated area where they are required. The invention will notify that person by sound, feel and visually. All three of these characteristics put together, all of one device, will help prevent an outstanding amount of accidents.

The invention is built into the safety glasses themselves, and will work when that person enters a zone where the safety glasses are required. The general physical configuration, materials and other characteristics of the safety glasses are in accordance with applicable requirements for safety glasses.

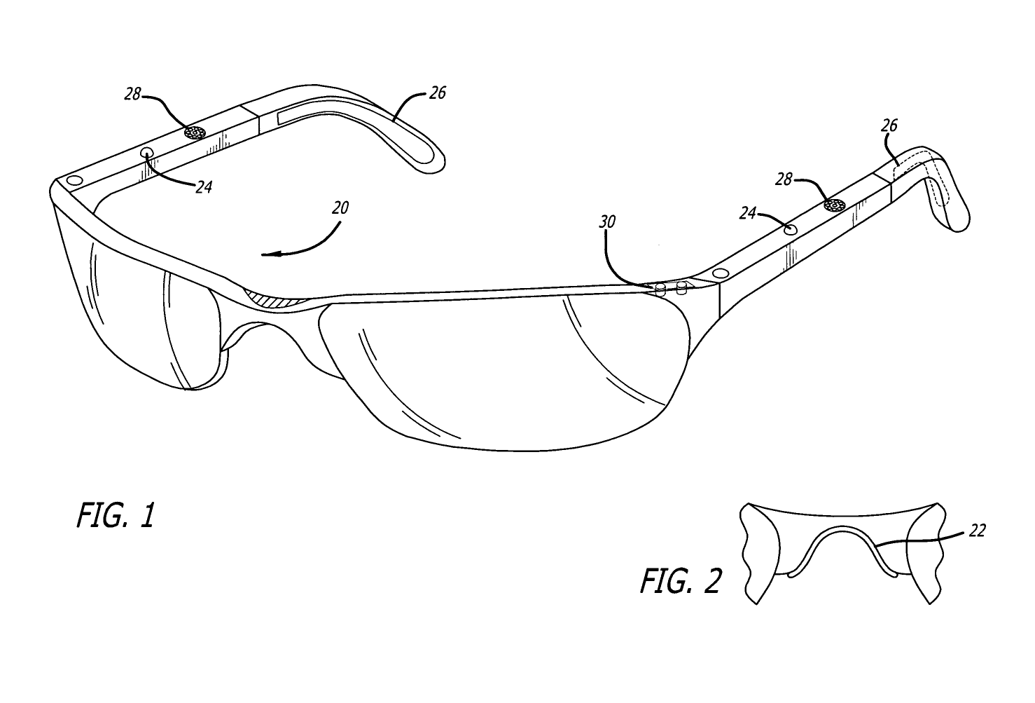

The invention comprises an electric pair of safety glasses, an exemplary embodiment of which is shown in FIG. 1. The preferred embodiment of the safety glasses 20 are equipped with a pressure deactivated microchip 22 in the section where the safety glasses rests on the bridge of ones nose (also see FIG. 2). The safety glasses 20 will also have a small red LED light 24 along with a small vibrator 26 on each side of the stems of the safety glass. The safety glasses are also equipped with a built-in speaker or speakers 28. The safety glasses are powered by one or more batteries

In use, wireless transmitters will be placed in or around the designated area were safety glasses are required. When someone wearing a pair of safety glasses walks into a designated area within range of a wireless transmitter where safety glasses are required, the pressure sensitive microchip will be deactivated. If the safety glasses are removed from that person's face, or not being worn when entering the area where safety glasses are required, the invention will then be activated. A small beeping alarm will be activated by the safety glasses through radio waves by a small transmitter associated with the microchip, using the frame of the safety glasses as an aerial, so that people wearing earmuffs with a radio built inside will be alerted by the alarm, which may be intercepted and relayed by the wireless transmitters. The stems of the safety glasses will then begin vibrating, and the two LED lights will begin flashing. When the battery becomes low, the two red LED flashing lights will begin going off.

The purpose of this invention is that when someone is working on a machine or in a designated area where safety glasses are required, that specific person will know to put their safety glasses on, and it will also remind other surrounding people not to operate a machine and to make sure that their work environment is a safe environment. The safety glasses contain a feel sense, the vibrators 26 in the stems of the glasses. This is useful for someone lifting their safety glasses to rest on the top of his/her head. The alarm on the safety glasses is the sound portion of the invention. This will notify surrounding people to not operate a machine and that the environment is not a safe one. The two LED lights that are flashing is the visual effect of the invention. This will notify people on a visual basis. This invention will solve preexisting problems because it will make different people aware that someone does not have a pair of safety glasses on, and it will prevent eye accidents.

The invention is a device which includes sound, visual, and a touch effect. The touch effect will be inserted in the stems of the safety glasses, and will take up seventy (70) percent of the stem. Then there is a light effect, which will take up ten (10) percent of the safety glass. Then the alarm, which will be closest to the ear, will take up the next ten (10) percent. Then the last ten (10) percent of the safety glass will be where the battery is inserted. The part of the safety glass that rests on top of the bridge of the person's nose is where the pressure sensitive microchip is located. Using the microchip located in the bridge of the safety glass will turn on the safety glasses when they enter the designated area and are in the vicinity of a wireless transmitter. The invention will turn off (deactivate) when it leaves the designated area where the safety glasses are required or be off (deactivated) as long as they are being worn by the user.

While a certain preferred embodiment of the present invention has been disclosed and described herein for purposes of illustration and not for purposes of limitation, it will be understood by those skilled in the art that various changes in form and detail may be made therein without departing from the spirit and scope of the invention.

What is claimed is:

1. An eye protection system comprising a pair of safety glasses having:
at least one battery;
a microchip powered by the battery and configured to be responsive to a signal from at least one wireless transmitter to activate the microchip when the safety glasses are in the vicinity of the wireless transmitter unless deactivated by pressure from the bridge of a users nose;
the safety glasses having a pair of stems, each having a speaker, a red LED and a vibrator coupled to the microchip and configured to sound an alarm, flash the LEDs and cause a vibration responsive to a signal from a wireless transmitter when the microchip is not deactivated by pressure from the bridge of the users nose.

2. The eye protection system of claim 1 wherein the microchip has a transmitter associated therewith to transmit an alarm when the microchip is not deactivated.
